(19) United States
(12) Patent Application Publication
(10) Pub. No.: US 2021/0032919 A1
(43) Pub. Date: Feb. 4, 2021

(54) REMOVABLE DAMPING MECHANISM AND CABINET HINGE ASSEMBLY INCLUDING SAME

(71) Applicant: Grass America Inc., Kernersville, NC (US)

(72) Inventors: Manfred PEER, Walkertown, NC (US); Daniel L. MOSS, High Point, NC (US); Georg DOMENIG, Kernersville, NC (US)

(73) Assignee: Grass America Inc., Kernersville, NC (US)

(21) Appl. No.: 16/935,669

(22) Filed: Jul. 22, 2020

Related U.S. Application Data
(60) Provisional application No. 62/880,205, filed on Jul. 30, 2019.

(51) Int. Cl. E05F 5/00; E05D 11/00; E05D 7/12

(52) U.S. Cl. CPC E05F 5/006; E05D 11/0054; E05D 7/123; E05Y 2201/474; E05Y 2201/258; E05Y 2201/46; E05Y 2900/20; E05Y 2201/11

(57) ABSTRACT

A damping mechanism is provided, including a damper housing, a damping assembly provided within the damper housing, and a damper cover assembly fitted to at least a portion of the damper housing. The damper cover assembly includes a damper cover and at least one connection member attached thereto. A recess is provided on a rearward side of the damper cover, and at least one receptacle is provided, defining an opening on a bottom surface of the damper cover and being adapted to receive and retain therein at least a portion of the at least one connection member of the damper cover assembly. The recess of the damper cover and the connection member of the damper cover assembly are cooperatively adapted to provide a mechanical connection between the damping mechanism and a hinge cup of a hinge assembly in a removable manner.

### BACKGROUND OF THE INVENTION

### 1. Field of the Invention

The present invention relates to a damping mechanism having structural features that enable the damping mechanism to be removably coupled to a hinge cup of a cabinet hinge assembly. The damping mechanism can be added to or removed from cabinet hinge assemblies as desired, without requiring industrial force or equipment, and without damaging the damping mechanism or the associated hinge hardware.

### 2. Background of the Invention

In the context of cabinets and door hinge assemblies, damping mechanisms that are provided in conjunction with hinge assemblies that have hinge cups are known in the industry, and are widely used. These damping (or damper) mechanisms operate in conjunction with cabinet hardware to control the opening and or closing motion speed of the doors in order to prevent slamming or damage. Since damping mechanisms are so widely used, it is not uncommon for most hinge assemblies to be provided with a damper mechanism. Typically, these damping mechanisms are pre-installed in the hinge cups of the hinge hardware by the hardware manufacturer and/or the cabinet manufacturer. Examples of such damping mechanisms are shown in U.S. Pat. Nos. 8,505,165 and 9,611,682.

The '682 patent discloses a damper mechanism that corresponds to the damper mechanism 700 shown in FIG. 1. The damper mechanism 700 includes a damper housing 3, a damping assembly 2 provided within the damper housing 3, and a damper cover 1′ fitted to a portion of the damper housing 3. The damper cover 1′ is a unitary, substantially rigid plastic member, typically formed as a single piece by injection molding or the like. The upper surface 103 of the damper cover 1 includes a recess 103a, which is situated in a substantially central portion of the arcuate rearward side 102, and which defines a step portion 102b between a plane of the upper surface 103 and a plane of a rearward side surface 102a of the damper cover (which extends in the thickness direction). The damper cover 1′ also includes permanent protrusions 112 that are integrally formed as part of the frontward side surface 101a thereof.

In order to assemble the damper mechanism 700 and the associated hinge hardware, the damper mechanism 700 is press-fit into the hinge cup 4 using a large, hydraulic ram to force forward a protrusion part (see, e.g., protrusion 41a in FIG. 6) formed on the inner surface of hinge cup 4 into the recess 103a/step 102b to forcibly form part of the connection between the damping mechanism 700 and the hinge cup 4. The protrusions 112 are likewise forcibly press-fit into openings in the hinge cup 4 during this process. Since this assembly process cannot be accomplished without the aid of significant force and industrial tools, the assembly process is limited to hardware/hinge manufacturers and cabinet manufacturers with suitable tools and expertise.

While it may be more convenient for cabinet manufactures and installers to use hardware kits including damping mechanisms, or hardware that is pre-loaded with a damper mechanism by the hardware manufacturer before installation in a cabinet setting, the damping mechanism increases the cost of the respective hinge hardware assembly. This can also be an issue when it is not necessary for every hinge on every door be provided with a damping mechanism (to prevent over-damping, as noted above), particularly for larger doors that have a plurality of hinges thereon. Once the damper mechanism 700 is positioned in the hinge cup 4, damper mechanism 700 is essentially permanently positioned, and it is not possible to remove the damper mechanism 700 by hand without damaging the damper mechanism 700 or the hinge cup 4.

Indeed, hinges provided with these types of damper mechanisms 700 will always have the damper mechanism therein, and if less damping is desired because an over-damped door closes much too slowly, the entire hinge assembly must be removed and an entirely different hinge assembly (without a damping mechanism) must installed on the cabinet instead. Accordingly, the cabinet makers and installers would need to remove and re-install hinge assemblies, or buy a variety of different hinge assemblies depending on the various door sizes, number of hinges, etc. in order to accommodate provide doors that exhibit an appropriate amount of damping. This process is tedious and costly. To date, there has not been a damping mechanism that can be inserted into and removed from the hinge cup by hand without damaging the associated parts.

In addition, the increased popularity of do-it-yourself installation also calls for the provision of a stand-alone damper mechanism that can be sold as an after-market product and easily hand-installed, in situ, in existing cabinets whose hardware may lack damper mechanisms, and which can be readily hand-removed from selected hinge assemblies by any user if the level of damping is not required.

In view of the drawbacks associated with the current damping mechanisms, it is desired to provide a more cost effective and efficient damper mechanism for a hinge assembly that can be added to select hinge assemblies by any given user (hardware or cabinet manufacturer, installer or home-owner) to provide the desired level of damping action without requiring substantial insertion force and/or industrial tools, and which can be readily removed from a hinge assembly, as needed, without causing damage to the parts and without requiring substantial force/industrial tools. Such a product has not been known heretofore.

### SUMMARY OF THE INVENTION

The present invention has been made in order to overcome the drawbacks of the prior art damping mechanisms and hinge assemblies discussed above.

According to one embodiment of the present invention, a damping mechanism is provided, including a damper housing, a damping assembly provided within the damper housing, and a damper cover assembly fitted to at least a portion of the damper housing. The damper cover assembly includes a damper cover and a connection member attached thereto. The damper cover has a recess provided on a rearward side thereof, and at least one receptacle defining an opening on a bottom surface of the damper cover assembly. The at least one receptacle of the damper cover is adapted to receive and retain therein at least a portion of the connection member of the damper cover assembly. The recess of the damper cover and the connection member of the damper cover assembly are cooperatively adapted to provide a mechanical connection between the damping mechanism and a hinge cup in a removable manner.

Preferably, the damper cover has an arcuate rearward side connecting two laterally opposed ends of a linear frontward side, an upper surface defining a plane extending in a first direction and an opposed lower surface extending in the first direction that is spaced apart from the first surface in a second direction that is substantially perpendicular with respect to the first direction. The upper surface of the damper cover includes the recess, which is situated in a substantially central portion of the arcuate rearward side and which defines a step portion between the plane of the upper surface and a plane of a rearward surface the damper cover. The at least one receptacle extends in a second direction, which is substantially perpendicular with respect to the first direction, from an opening formed in the bottom surface toward a terminal end situated in an interior portion of the damper cover. The at least one receptacle is situated proximate at least one of the laterally opposed ends of the frontward side of the damper cover, wherein the at least one receptacle is adapted to receive and retain at least a portion of the at least one connection member of the damper cover assembly.

According to one aspect of the present invention, the at least one connection member of the damper cover assembly comprises at least one magnet. The magnet(s) are press-fit so as to be situated within the receptacle(s) of the damper cover assembly. When the damping mechanism is press-fit into the hinge cup, the magnets of the damper cover assembly provide a magnetic connection between the damping mechanism and the metal hinge cup. In addition, a physical connection between the damping mechanism and the hinge cup is further made between the recess/step in the damper cover that engages a corresponding protrusion on the inner surface of the hinge cup when the damping mechanism is press-fit therein. This configuration enables the damping mechanism to be readily inserted into the hinge cup without the need to the use of tools, which significantly improves the ease of installation and enables end-users of various sophistication to add a damping mechanism to an existing hinge cup (pre-installation), or to a hinge cup in an installed hinge assembly, as desired.

Conversely, if desired, a damping mechanism including magnetic connection member(s) as part of the damper cover assembly can be readily removed from the hinge cup using minimal tools (i.e., a simple nail needle, flat head screwdriver or other prying object) and minimal force (i.e., simple hand force), without causing the destruction of the hinge cup or the damping mechanism, and without causing damage to the magnets of the damper cover assembly themselves. If re-use of the damping mechanism is desired, the same damping mechanism can be used again, or if necessary, new magnets can be inserted into the receptacles of the damper cover and used to again help provide secure coupling between the hinge cup and the damping mechanism in conjunction with the recess/step in the damper cover.

According to another aspect, the at least one connection member of the damper cover assembly comprises a flex-tab (clip). Preferably, the flex-tab comprises a first portion adapted to be received and retained in the receptacle, a second portion, spaced apart from the first portion, that abuts a front surface of the damper cover, and a third portion connecting the first and second portions in a direction that is parallel with respect to the first direction. The second portion of the flex-tab comprises a protrusion extending a distance away from the front surface of the damper cover in the first direction.

Preferably, the flex-tab is made from a resilient material, such as a plastic. Suitable examples of such a plastic material for the flex-tab include, but are not limited to, nylon, polypropylene and ABS. The flex-tab(s) are press-fit into the receptacles of the damper cover. When damping mechanism is press-fit into the hinge cup, a physical connection between the damping mechanism and the hinge cup is made between the recess/step in the damper cover that engages a corresponding protrusion on the inner surface of the hinge cup, and the protrusions of the flex-clips of the damper cover assembly engage a corresponding recess(es) on the hinge cup in a press-fit manner. In this way, the flex tab(s) aid in providing a secure connection between the damping mechanism and the hinge cup, but retain sufficient flexibility so that the damping mechanism can be readily inserted into the hinge cup by hand, without the need for tools. This significantly improves the ease of installation and enables end-users of various sophistication to install a damping mechanism to an existing hinge cup (pre-installation), or to a hinge cup in an installed hinge assembly, as desired.

Conversely, if desired, a damping mechanism including a damper cover assembly having flex-clip connection member(s) can also be readily removed by gently prying the damping mechanism away from the hinge cup using minimal tools (i.e., a simple prying tool like a nail needle or flat head screwdriver) and minimal force (i.e., simple hand force) without causing the destruction of the hinge cup or the damping mechanism. It may be possible to remove the damping mechanism without damaging the flex-clip(s) of the damper cover assembly, as well. In that case, when re-use of the damping mechanism is desired, it can be re-inserted and connected to the same or a different hinge cup, as desired. Since the flex-clip connection member inserts are small, plastic members that are easily manufactured at a low cost, and whose replacement does not pose a significant cost or efficiency factor, the flex-slip(s) of the damper cover assembly can be readily replaced if they are damaged upon removal. If re-use of the damping mechanism is desired, new flex-clip(s) can be inserted into the receptacles of the damper cover to again provide secure coupling between the hinge cup and the damping mechanism in conjunction with the recess/step in the damper cover.

It is further preferred that the at least one receptacle of the damper cover comprises two receptacles, each positioned proximate a respective one of the laterally opposed ends of the frontward side of the damper cover. In accordance with this aspect, the at least one connection member of the damper cover assembly preferably comprises two connection members, such as two magnets or two flex-tabs (clips).

According to another embodiment of the present invention, a hinge assembly for mounting a furniture door to a furniture housing is provided. The hinge assembly includes a fixation section installed on the furniture housing, a hinge cup affixed to the furniture door and pivotally connected to the fixation section, and a damping mechanism provided in the hinge cup and adapted to contact the fixation section to dampen the relative movement between the fixation section and the hinge cup as the furniture door closes on the furniture housing. The damping mechanism comprises an engagement mechanism adapted to mechanically couple the damping mechanism to the hinge cup in a removable manner.

Preferably, the damping mechanism comprises a damper housing, a damping assembly provided within the damper housing, and a damper cover assembly fitted to at least a portion of the damper housing. The damper cover assembly includes a damper cover and at least one connection member attached to the damper cover. The upper surface of the damper cover includes a recess that is situated in a substantially central portion of the arcuate rearward side and which defines a step portion between the plane of the upper surface and a plane of a rearward surface the damper cover. The damper cover includes at least one receptacle, extending in a second direction, which is substantially perpendicular with respect to the first direction, from an opening formed in the bottom surface toward a terminal end situated in an interior portion of the damper cover. The at least one receptacle of the damper cover is situated proximate at least one of the laterally opposed ends of the frontward side of the damper cover assembly, wherein the at least one receptacle is adapted to receive and retain therein at least a portion of the at least one connection member of the damper cover assembly.

The recess of the damper cover engages a corresponding protrusion provided on an inner surface of the hinge cup, and the at least one connection member of the damper cover assembly engages at least another portion of the hinge cup to cooperatively couple the damping mechanism to the hinge cup of the hinge assembly in a removable manner.

According to one aspect of the present invention, the at least one connection member of the damper cover assembly comprises a magnet, and according to another aspect, the at least one connection member of the damper cover assembly comprises a flex-tab. It is further preferred that the at least one receptacle of the damper cover comprises two receptacles, each positioned proximate a respective one of the laterally opposed ends of the frontward side of the damper cover. In accordance with this aspect, the at least one connection member of the damper cover assembly preferably comprises two connection members, such as two magnets or two flex-tabs.

### BRIEF DESCRIPTION OF THE DRAWINGS

FIG. 1 is an exploded perspective view of a prior art damping mechanism 700, which is not functionally removable once inserted into a hinge cup of a hinge assembly;

FIG. 2 is an exploded perspective view of a removable damping mechanism 100A according to one aspect of the present invention, including two magnetic connection members 10 of the damper cover assembly 1A;

FIGS. 3(a)-3(g) are various views of the removable damping mechanism 100A shown in FIG. 2, removably coupled with a hinge cup 4 to comprise an assembly 500A (a hinge cup assembly), wherein

FIG. 3(a) is a perspective pre-assembly view,

FIG. 3(b) is a perspective view of the assembly 500A,

FIG. 3(c) is an enlarged view of the receptacle 105 of the damper cover assembly 1A and the magnet 10 situated therein,

FIG. 3(d) is a bottom view of the damper mechanism 100A,

FIG. 3(e) is a top view of the assembly 500A,

FIG. 3(f) is a front view of the assembly 500A, and

FIG. 3(g) is a cross-sectional view of the assembly 500A taken through line A-A in FIG. 3(f);

FIG. 4 is an exploded perspective view of a removable damping mechanism 100B according to another aspect of the present invention, including two flex-tab (clip) connection members 11 of the damper cover assembly 1B;

FIGS. 5(a)-5(g) are various views of the removable damping mechanism 100B shown in FIG. 4, removably coupled with a hinge cup 4 to comprise an assembly 500B (a hinge cup assembly), wherein

FIG. 5(a) is a perspective pre-assembly view,

FIG. 5(b) is a perspective view of the assembly 500B,

FIG. 5(c) is an enlarged view of the receptacle 105 of the damper cover assembly 1B and the flex-tab 11 situated therein,

FIG. 5(d) is a bottom view of the damper mechanism 100B,

FIG. 5(e) is a top view of the assembly 500B,

FIG. 5(f) is a front view of the assembly 500B, and

FIG. 5(g) is a cross-sectional view of the assembly 500B taken through line B-B in FIG. 5(f); and

FIG. 6 is a perspective view of a cabinet hinge assembly 600 including a damping mechanism 100A or 100B according to either FIG. 2 or FIG. 4 inserted in and removably coupled to the hinge cup 4.

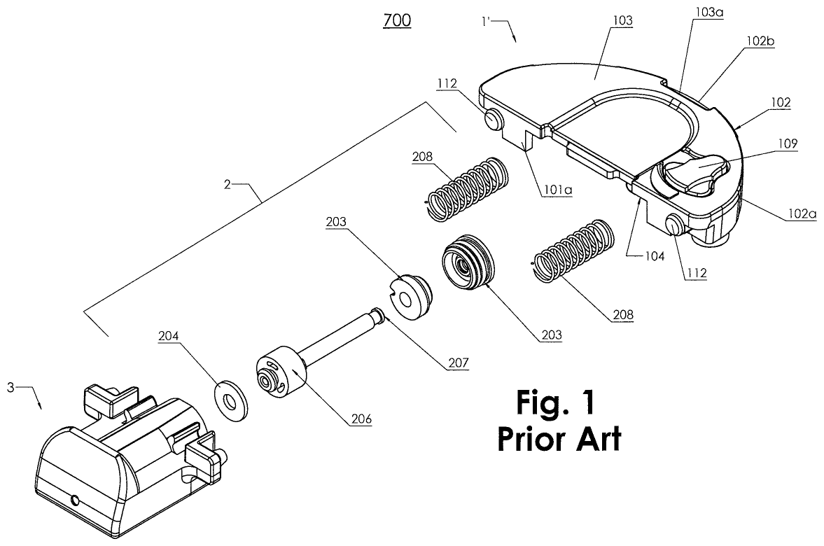

### DETAILED DESCRIPTION OF THE INVENTION

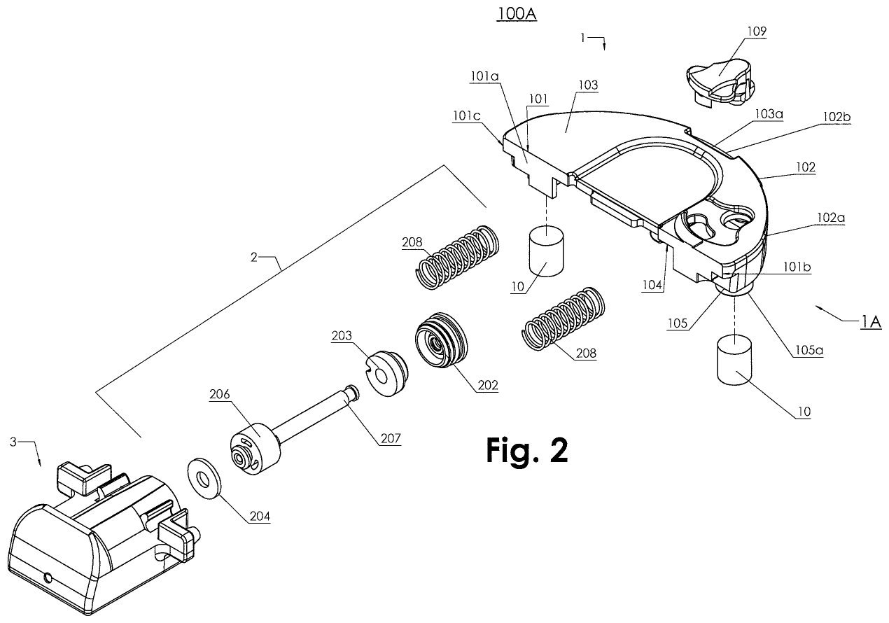

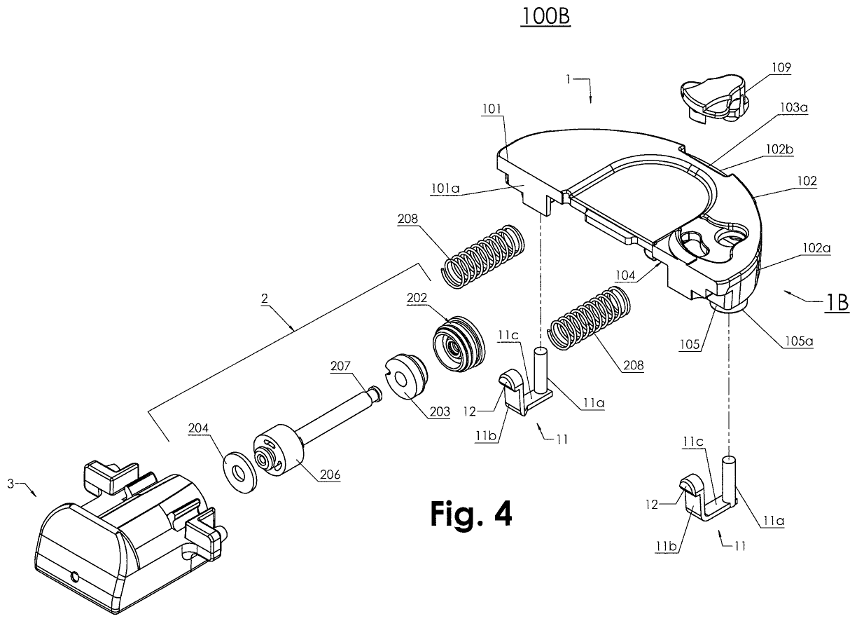

Like reference numbers have been used to designate like parts among the various drawings. As shown in FIGS. 2 and 4, the damping mechanisms 100A, 100B each include a damper housing 3, a damping assembly 2 provided within the damper housing 3, and a damper cover assembly 1A, 1B, including a damper cover 1 and a connection members 10 or 11, fitted to at least a portion of the damper housing 3.

The damper cover 1 has an arcuate rearward side 102 connecting two laterally opposed ends 101c, 101d of a linear frontward side 101a, an upper surface 103 defining a surface plane extending in a first direction (i.e., horizontal). The damper cover 1 also has an opposed lower surface 104 defining a surface plane extending in the first direction, and which is spaced a distance apart from the upper surface 103 in a second direction (thickness/vertical direction) that is substantially perpendicular with respect to the first direction.

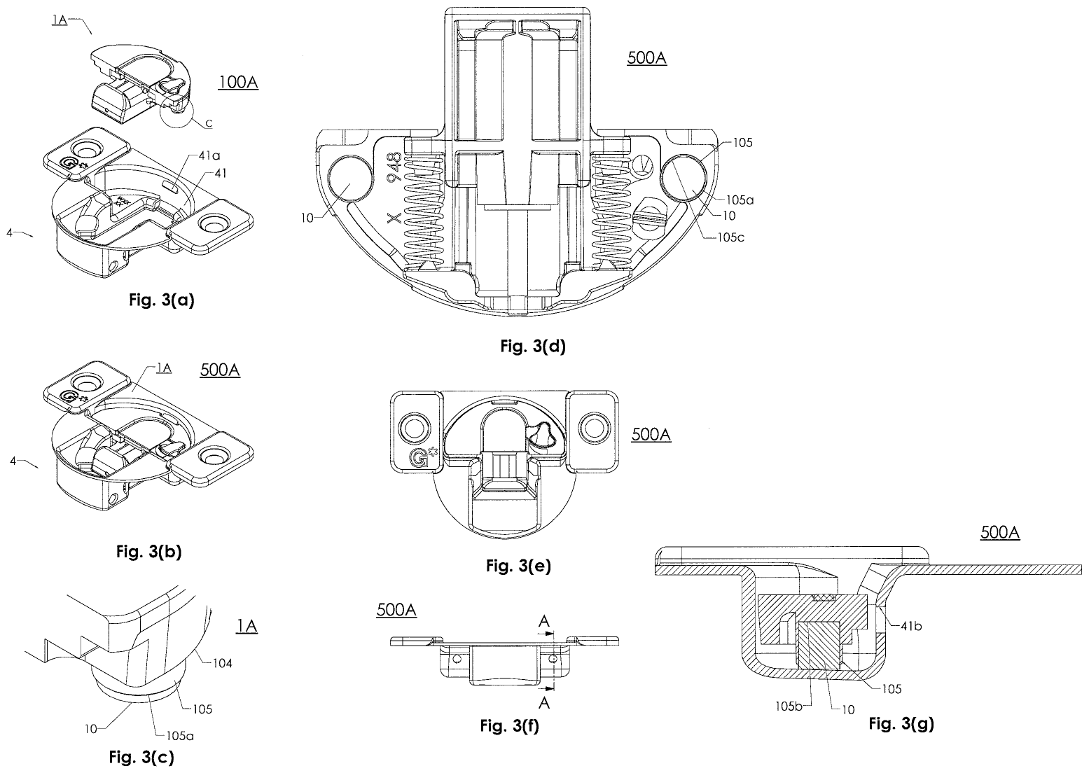

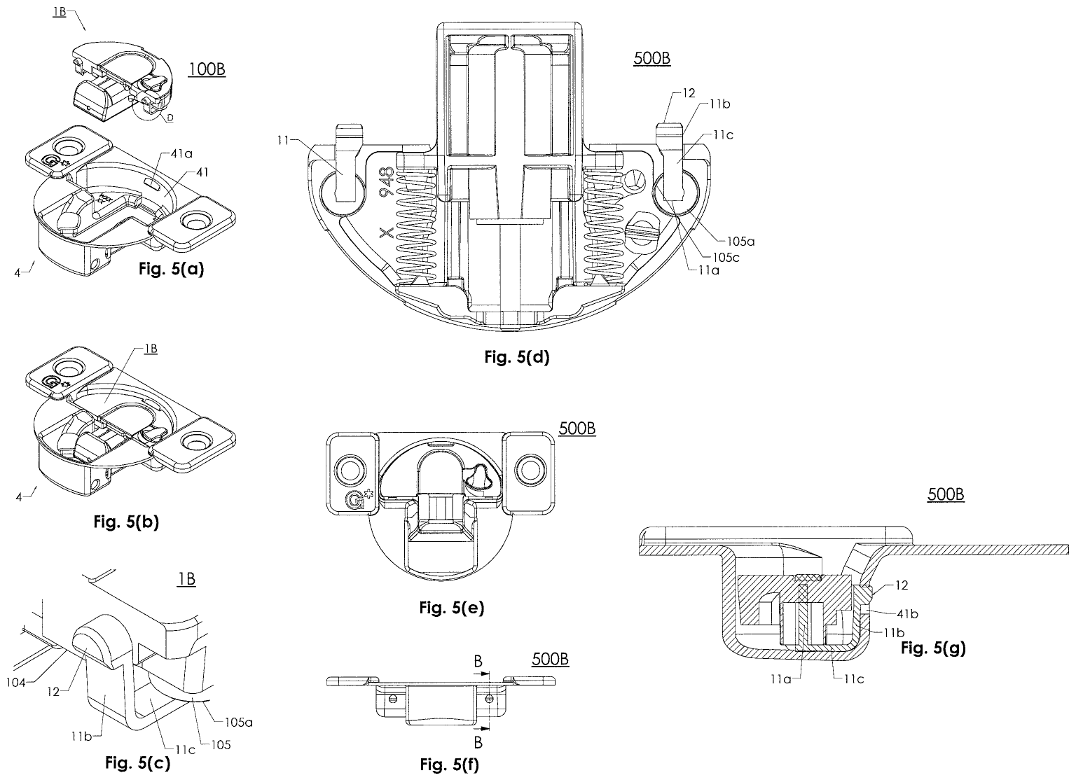

The upper surface 103 of the damper cover 1 includes a recess 103a, which is situated in a substantially central portion of the arcuate rearward side 102, and which defines a step portion 102b between the plane of the upper surface 103 and a plane of a rearward side surface 102a of the damper cover 1 (which extends in the second/thickness direction). When the damping mechanism 110A, 100B is press-fit into the hinge cup 4, the recess 103a/step 102b receives a corresponding protrusion 41a from the inner surface 41 of the hinge cup 40 (see, e.g., FIGS. 3 and 5). This forms part of the connection between the damping mechanism 100A, 100B and the hinge cup 4.

The damper cover 1 includes least one receptacle 105 that extends in the second direction from an opening 105a formed in the bottom surface 104 toward a terminal end 105b situated in an interior portion of the damper cover assembly 1. Preferably, and as shown in the accompanying drawings, the at least one receptacle 105 of the damper cover 1 comprises two receptacles 105, each positioned proximate a respective one of the laterally opposed ends 101c, 101b of the frontward side 101 of the damper cover 1. The at least one receptacle 105 is adapted to receive and retain (press-fit) at least a portion of the connection member 10 or 11 of the damper cover assembly 1A, 1B to help secure the removable connection between the damping mechanism 100A, 100B and the hinge cup 4.

The at least one connection member of the damper cover assembly 1A comprises a magnet 10, and the at least one connection member of the damper cover assembly 1B comprises a flex-tab (clip) 11. Preferably, the at least one connection member of the damper cover assembly 1A, 1B preferably comprises two connection members, such as two magnets 10 or two flex-tabs 11. The recess/step 103a/102b of the damper cover 1 and the respective connection members (10 or 11) of the damper cover assembly 1A, 1B together define an engagement mechanism that is cooperatively adapted to provide a mechanical connection between the respective damping mechanisms 100A, 100B and a hinge cup 4 (see, e.g., FIGS. 3, 5 and 6) in a removable manner.

As shown in FIGS. 2 and 3, the connection member 10 of the damper cover assembly 1A of the damping mechanism 100A is a magnet having a substantially cylindrical shape to be accommodated within the receptacle 105 of the damper cover assembly 1 in a press-fit manner. The shape of the magnet 10 is not critical, so long as the outer diameter and cross-sectional shape enable the magnet 10 to be sufficiently received and retained within the respective receptacles 105.

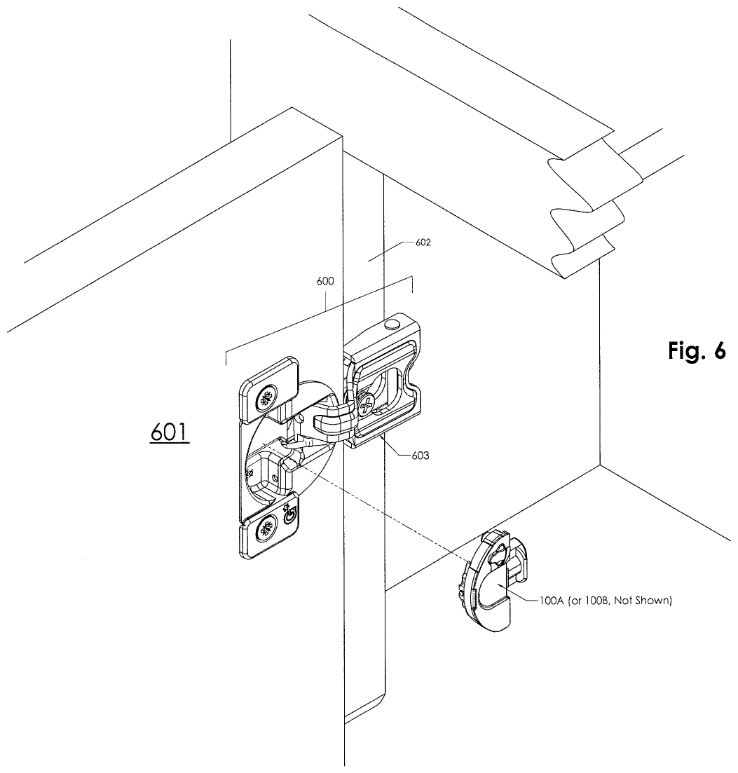

When the damping mechanism 100A is press-fit into the hinge cup 4 (see, e.g., FIGS. 3 and 6), the magnets 10 (proximate the exposed ends thereof) of the damper cover assembly 1A engage the metallic inner surface 41 of the hinge cup 4 to provide a magnetic connection therebetween.

As shown in FIGS. 4 and 5, for example, the connection member 11 of the damper cover assembly 1B of the damping mechanism 100B is a flex-tab having a first portion 11a that is adapted to be received and retained (press-fit) in the receptacle 105 of the damper cover assembly 1, a second portion 11b, spaced apart from the first portion, that abuts the frontward side surface 101a of the damper cover 1, and a third portion 11c connecting the first and second portions 11a, 11b in a direction that is parallel with respect to the first direction. The second portion 11b of the flex-tab 11 comprises a protrusion 12 extending a distance away from the frontward side surface 101 of the damper cover 1 in the first direction. When the damping mechanism 100B is press-fit into the hinge cup 4, the protrusion 12 of the flex tab 11 of the damper cover assembly 1B engages a corresponding recess 41b in the hinge cup 4 (see, e.g. FIG. 5(g)).

The flex-tab 11 of the damper cover assembly 1B is preferably a unitary body made of a plastic material, such as nylon, by an injection molding process. The flex-tab 11 of the damper cover assembly 1B thereby exhibits a spring-like resiliency, which enables the insertion and removal of the damping mechanism 100B from the hinge cup 4.

FIG. 6 shows the hinge assembly 600 for mounting a furniture door 601 to a furniture housing 602. The hinge assembly 600 includes a fixation section 603 installed on the furniture housing, a hinge cup 4 affixed to the furniture door 601 and pivotally connected to the fixation section 603, and a damping mechanism 100A or 100B provided in the hinge cup 4 and adapted to contact the fixation section 603 to dampen the relative movement between the fixation section 603 and the hinge cup 4 as the furniture door 601 closes on the furniture housing 602.

The damping mechanism 100A or 100B of the assembly 600 comprises an engagement mechanism adapted to mechanically couple the damping mechanism 100A or 100B to the hinge cup 4 in a removable manner. The engagement mechanism includes the recess/step 103a/102b of the damper cover 1 that engages the corresponding protrusion 41a provided on an inner surface 41 of the hinge cup 4, and the at least one connection member (10 or 11) of the damper cover assembly 1A, 1B that engages at least another portion (i.e., recesses/openings 41b) of the hinge cup 4 (see, e.g., FIGS. 3 and 5) to cooperatively couple the damping mechanism 100A or 100B to the hinge cup 4 of the hinge assembly 600.

In that manner, the damping mechanism 100A or 100B can be easily snap-fit into place in the hinge cup 4 using only hand-force and a simple tool or in connection with an automated assembly process. The damping mechanism 100A or 100B can also be readily removed from the hinge cup 4 by gently prying the rearward side 102 proximate the step 102b/recess 103a aera with a simple prying tool, using only hand-force and without damaging the damping mechanism 100A, 100B or the hinge cup 4.

### LIST OF REFERENCE NUMBERS USED IN THE DRAWINGS

700: damping mechanism (prior art)
100A: damping mechanism (1^{st} aspect)
100B: damping mechanism (2^{nd} aspect)
   1′: prior art damper cover
   112: integral/permanent protrusions
   1A: damper cover assembly
      10: magnetic connection member(s)
   1B: damper cover assembly
      11: clip-in, flex-tab connection member(s)
         11a: 1^{st} part/portion
         11b: 2^{nd} part/portion
         11c: 3^{rd} part/portion
         12: protrusion
   1: damper cover (same for both 1A and 1B)
      101: frontward side
      101a: frontward side surface
      101b: frontward lateral side end
      101c: frontward lateral side end
      102: arcuate rearward side
      102a: rearward side surface
      102b: step
      103: upper/top surface
      103a: recess
      104: lower/bottom surface
      105: receptacle (for 1^{st} or 2^{nd} aspects)
      105a: receptacle opening
      105b: receptacle terminal end
      105c: receptacle inner surface
      109: damper switch
   2: damping assembly
      202: piston lid
      203: balancing foam
      204: washer
      206: piston
      207: piston notch
      208: damper spring(s)
   3: damper housing
   4: hinge cup
      41: hinge cup interior wall
      41a: protrusion
      41b: recess
500A: hinge cup assembly (1^{st} aspect)
500B hinge cup assembly (2^{nd} aspect)
600: hinge assembly
   601: furniture door
   602: furniture housing
   603: fixation section

What is claimed is:

1. A damping mechanism, comprising:
a damper housing;
a damping assembly provided within the damper housing; and
a damper cover assembly fitted to at least a portion of the damper housing;
wherein the damper cover assembly comprises a damper cover and at least one connection member attached thereto,
wherein the damper cover has a recess provided on a rearward side thereof, and at least one receptacle defining an opening on a bottom surface of the damper cover, and wherein the at least one receptacle is adapted to receive and retain therein at least a portion of the at least one connection member of the damper cover assembly, and
wherein the recess of the damper cover and the connection member of the damper cover assembly are cooperatively adapted to provide a mechanical connection between the damping mechanism and a hinge cup of a hinge assembly in a removable manner.

2. The damping mechanism of claim 1, wherein the at least one connection member of the damper cover assembly comprises a magnet.

3. The damping mechanism of claim 1, wherein the at least one connection member of the damper cover assembly comprises a flex-tab.

4. A damping mechanism, comprising:
a damper housing;
a damping assembly provided within the damper housing; and
a damper cover assembly fitted to at least a portion of the damper housing, the damper cover assembly comprising a damper cover and at least one connection member attached thereto,
wherein the damper cover has an arcuate rearward side connecting two laterally opposed ends of a linear frontward side, an upper surface defining a plane extending in a first direction and an opposed lower surface extending in the first direction that is spaced apart from the first surface in a second direction that is substantially perpendicular with respect to the first direction;
wherein the upper surface of the damper cover includes a recess that is situated in a substantially central portion of the arcuate rearward side and which defines a step portion between the plane of the upper surface and a plane of a rearward surface the damper cover,
wherein the damper cover includes at least one receptacle, extending in a second direction, which is substantially perpendicular with respect to the first direction, from an opening formed in the bottom surface toward a terminal end situated in an interior portion of the damper cover, the at least one receptacle of the damper cover assembly being situated proximate at least one of the laterally opposed ends of the frontward side of the damper cover, wherein the at least one receptacle of the damper cover assembly is adapted to receive and retain at least a portion of the at least one connection member of the damper cover assembly, and
wherein the recess of the damper cover and the connection member of the damper cover assembly cooperatively define an engagement mechanism of the damper mechanism, whereby the damper mechanism is adapted to be connected to a hinge cup of a hinge assembly via the engagement mechanism in a removable manner.

5. The damping mechanism of claim 4, wherein the at least one connection member of the damper cover assembly comprises a magnet.

6. The damping mechanism of claim 4, wherein the at least one connection member of the damper cover assembly comprises a flex-tab.

7. The damping mechanism of claim 6, wherein the flex-tab of the damper cover assembly comprises a first portion adapted to be received and retained in the receptacle, a second portion, spaced apart from the first portion, that abuts a front surface of the damper cover, and a third portion connecting the first and second portions in a direction that is parallel with respect to the first direction.

8. The damping mechanism of claim 7, wherein the second portion of the flex-tab of the damper cover assembly comprises a protrusion extending a distance away from the front surface of the damper cover in the first direction.

9. The damping mechanism of claim 4, wherein the at least one receptacle of the damper cover assembly comprises two receptacles.

10. The damping mechanism of claim 9, wherein the at least one connection member of the damper cover assembly comprises two connection members.

11. The damping mechanism of claim 10, wherein the at least one connection member of the damper cover assembly comprises two magnets.

12. The damping mechanism of claim 10, wherein the at least one connection member of the damper cover assembly comprises two flex-tabs.

13. A hinge assembly for mounting a furniture door to a furniture housing, the hinge assembly comprising:
a fixation section installed on the furniture housing;
a hinge cup affixed to the furniture door and pivotally connected to the fixation section; and
a damping mechanism, including a damper cover assembly, provided in the hinge cup and adapted to contact the fixation section to dampen the relative movement between the fixation section and the hinge cup as the furniture door closes on the furniture housing,
wherein the damper cover assembly comprises an engagement mechanism adapted to mechanically couple the damping mechanism to the hinge cup in a removable manner.

14. The hinge assembly according to claim 13, wherein the damping mechanism comprises:
a damper housing;
a damping assembly provided within the damper housing; and
the damper cover assembly, fitted to at least a portion of the damper housing;
wherein the damper cover has an arcuate rearward side connecting two laterally opposed ends of a linear frontward side, an upper surface defining a plane extending in a first direction and an opposed lower surface extending in the first direction that is spaced apart from the first surface in a second direction that is substantially perpendicular with respect to the first direction;
wherein the upper surface of the damper cover includes a recess that is situated in a substantially central portion of the arcuate rearward side and which defines a step portion between the plane of the upper surface and a plane of a rearward surface the damper cover,
wherein the damper cover includes at least one receptacle, extending in a second direction, which is substantially perpendicular with respect to the first direction, from an opening formed in the bottom surface of the damper cover toward a terminal end situated in an interior portion of the damper cover, the at least one receptacle of the damper cover being situated proximate at least one of the laterally opposed ends of the frontward side of the damper cover, wherein the at least one receptacle is adapted to receive and retain therein at least a portion of the at least one connection member of the damper cover assembly, and
wherein the recess of the damper cover assembly engages a corresponding protrusion provided on an inner surface of the hinge cup and the at least one connection member of the damper cover assembly engages at least another portion of the hinge cup to cooperatively couple the damping mechanism to the hinge cup of the hinge assembly in a removable manner.

15. The damping mechanism of claim 14, wherein the at least one connection member of the damper cover assembly comprises a magnet.

16. The damping mechanism of claim 14, wherein the at least one connection member of the damper cover assembly comprises a flex-tab.

17. The damping mechanism of claim 16, wherein the flex-tab of the damper cover assembly comprises a first portion adapted to be received and retained in the receptacle, a second portion, spaced apart from the first portion, that abuts a front surface of the damper cover, and a third portion connecting the first and second portions in a direction that is parallel with respect to the first direction.

18. The damping mechanism of claim 17, wherein the second portion of the flex-tab of the damper cover assembly comprises a protrusion extending a distance away from the front surface of the damper cover in the first direction.

19. The damping mechanism of claim 14, wherein the at least one receptacle of the damper cover assembly comprises two receptacles.

20. The damping mechanism of claim 19, wherein the at least one connection member of the damper cover assembly comprises two connection members.
